(19) United States
(12) Patent Application Publication
(10) Pub. No.: US 2026/0342878 A1
(43) Pub. Date: Oct. 29, 2026

(54) DATA COMMUNICATION SYSTEM, CENTER DEVICE, VEHICULAR DEVICE, DATA PROCESSING METHOD, AND DATA PROCESSING PROGRAM

(71) Applicant: DENSO CORPORATION, Kariya-city (JP)

(72) Inventors: Mamoru HOSOKAWA, Kariya-city (JP); Kensho Taki, Kariya-city (JP); Shinichi Koike, Kariya-city (JP)

(21) Appl. No.: 19/709,063

(22) Filed: Jun. 16, 2026

Related U.S. Application Data
(63) Continuation of application No. PCT/JP2024/037396, filed on Oct. 21, 2024.

(30) Foreign Application Priority Data
Dec. 28, 2023 (JP) 2023-222244

(51) Int. Cl. H04L 67/12; H04L 12/40

(52) U.S. Cl. CPC H04L 67/12; H04L 12/40013

(57) ABSTRACT

A center device generates trigger conditions for detecting a given scene of the vehicle, generates a combining way of the trigger conditions, generates a collection data list corresponding to the trigger conditions, delivers the trigger conditions, the combining way, and the collection data list to a vehicular device. The vehicular device acquires detection data required for trigger condition determinations, performs the trigger condition determinations based on the detection data according to the combining way of the trigger conditions, generates collection data based on determination results of the trigger condition determinations, and transmits the collection data to the center device.

### CROSS REFERENCE TO RELATED APPLICATION

This application is a continuation application of International Patent Application No. PCT/JP2024/037396 filed on Oct. 21, 2024, which designated the U.S. and claims the benefit of priority from Japanese Patent Application No. 2023-222244 filed on Dec. 28, 2023. The entire disclosures of all of the above applications are incorporated herein by reference.

### TECHNICAL FIELD

The present disclosure relates to a data communication system, a center device, a vehicular device, a data processing method, and a data processing program.

### BACKGROUND

There is provided a data communication system in which a center device collects vehicle data from an unspecified number of vehicles.

### SUMMARY

According to one aspect of the present disclosure, a center device generates trigger conditions for detecting a given scene of the vehicle and generates a combining way of the trigger conditions. The center device may generate a collection data list corresponding to the trigger conditions, deliver the trigger conditions, the combining way, and the collection data list to a vehicular device. The vehicular device may acquire detection data required for trigger condition determinations, perform the trigger condition determinations based on the detection data according to the combining way of the trigger conditions, generate collection data based on determination results of the trigger condition determinations, and transmit the collection data to the center device.

### BRIEF DESCRIPTION OF DRAWINGS

Objects, features and advantages of the present disclosure will become apparent from the following detailed description made with reference to the accompanying drawings. In the drawings:

FIG. 1 is a functional block diagram illustrating an overall configuration of an embodiment;

FIG. 2 is a functional block diagram of a center device;

FIG. 3 is a functional block diagram of a vehicular device;

FIG. 4 is a functional block diagram of a controller unit of the center device;

FIG. 5 is a diagram illustrating a case where a return value is returned;

FIG. 6 is a diagram illustrating a trigger condition file;

FIG. 7 is a diagram illustrating a combining way file;

FIG. 8 is a diagram illustrating a collection data list file;

FIG. 9 is a diagram illustrating a case where the return value is not returned;

FIG. 10 is a diagram illustrating a trigger condition file;

FIG. 11 is a diagram illustrating a combining way file;

FIG. 12 is a diagram illustrating a collection data list file;

FIG. 13 is a functional block diagram of the controller unit of the vehicular device;

FIG. 14 is a flowchart illustrating the process of the vehicular device;

FIG. 15 is a flowchart illustrating the process of the vehicular device;

FIG. 16 is a flowchart illustrating the process of the center device; and

FIG. 17 is a diagram illustrating a process flow.

### DETAILED DESCRIPTION

There is provided a data communication system in which a center device collects vehicle data from an unspecified number of vehicular devices by receiving the vehicle data transmitted from the vehicular devices mounted on the unspecified number of vehicles. For example, there is a technology for reducing a transmission frequency of access requests from vehicular devices to a center device and for reducing processing load of authentication for collecting vehicle data.

Users may experience dissatisfaction when using the vehicle. An assumed technology for specifying user dissatisfaction may directly or indirectly specify user dissatisfaction. For example, when a Lane Tracing Assist (hereinafter referred to as LTA) function is active during highway driving, it is possible to directly determine that the user experiences dissatisfaction by determining that the user performs a steering operation to cancel the LTA function. For example, by determining that the user refuses to use an auto-parking function in response to a recommendation to use the auto-parking function at start of parking, it is possible to directly determine that the user experiences dissatisfaction. Furthermore, after improving the LTA function based on another user's request, it is possible to indirectly determine that the user experiences dissatisfaction by determining that the behavior of the LTA function logic during operation differs from the behavior of the improved LTA function logic. Given these circumstances, for example, there are needs for vehicle manufacturers and application development vendors to analyze scenes where users experience dissatisfaction and to improve vehicle functionalities.

In this case, in order to analyze the scene where the user experienced dissatisfaction, a center device generates a trigger condition for detecting a scene where a user experiences dissatisfaction, and collects from the vehicular device and analyzes such data as sensor values from sensors and control statuses of systems around the time the trigger condition is met. However, it is not easy to generate a trigger condition with high accuracy from the outset, nor is it easy to manage trigger condition improvement or reuse.

The present disclosure provides technology for accurately generating a trigger condition for detecting a scene where users express dissatisfaction, and for facilitating management of trigger condition improvements and reuse.

According to a first aspect of the present disclosure, a data communication system is provided that comprises a center device and a vehicular device mounted on a vehicle which are capable of data communication with each other. The center device includes at least one computer, including a processor that executes a program and/or a dedicated circuit, implementing: a trigger condition generator that generates trigger conditions for detecting a given scene of the vehicle; a combining way generator that generates a combining way of the trigger conditions; a collection data list generator that generates a collection data list corresponding to the trigger conditions; a deliverer that delivers the trigger conditions, the combining way, and the collection data list to the vehicular device; and a collection data acquirer that acquires collection data indicated in the collection data list from the vehicular device. The vehicular device includes at least one computer, including a processor that executes a program and/or a dedicated circuit, implementing: a detection data acquirer that acquires detection data required for trigger condition determinations; a trigger condition determiner that performs the trigger condition determinations based on the detection data according to the combining way of the trigger conditions; a data collector that generates the collection data based on determination results of the trigger condition determinations; and a collection data transmitter that transmits the collection data to the center device.

According to a second aspect of the present disclosure, a center device capable of data communication with a vehicular device mounted on a vehicle is provided, wherein the vehicular device, based on detection data required for trigger condition determinations, performs the trigger condition determinations according to a combining way of trigger conditions, generates collection data based on determination results of the trigger condition determinations, and transmits the collection data to the center device. The center device comprises at least one computer, including a processor that executes a program and/or a dedicated circuit, implementing: a trigger condition generator that generates trigger conditions for detecting a given scene of the vehicle; a combining way generator that generates a combining way of the trigger conditions; a collection data list generator that generates a collection data list corresponding to the trigger conditions; a deliverer that delivers the trigger conditions, the combining way, and the collection data list to the vehicular device; and a data acquirer that acquires the collection data from the vehicular device.

According to a third aspect of the present disclosure, a vehicular device mounted on a vehicle and capable of data communication with a center device is provided, wherein the center device generates trigger conditions for detecting a given scene of the vehicle, generates a combining way of the trigger conditions, generates a collection data list corresponding to the trigger conditions, delivers the trigger conditions, the combining way, and the collection data list to the vehicular device, and acquires collection data from the vehicular device. The vehicular device comprises at least one computer, including a processor that executes a program and/or a dedicated circuit, implementing: a detection data acquirer that acquires detection data required for trigger condition determinations; a trigger condition determiner that performs the trigger condition determinations based on the detection data according to the combining way of the trigger conditions; a collection data generator that generates the collection data based on determination results of the trigger condition determinations; and a data transmitter that transmits the collection data to the center device.

According to a fourth aspect of the present disclosure, a data processing method executed in a data communication system in which a center device and a vehicular device mounted on a vehicle are capable of data communication with each other is provided. The data processing method comprises: by the center device, generating trigger conditions for detecting a given scene of the vehicle; by the center device, generating a combining way of the trigger conditions; by the center device, generating a collection data list corresponding to the trigger conditions; by the center device, delivering the trigger conditions, the combining way, and the collection data list to the vehicular device; by the center device, acquiring collection data indicated in the collection data list from the vehicular device; by the vehicular device, acquiring detection data required for trigger condition determinations; by the vehicular device, performing the trigger condition determinations based on the detection data according to the combining way of the trigger conditions; by the vehicular device, generating collection data based on determination results of the trigger condition determinations; and by the vehicular device, transmitting the collection data to the center device.

According to a fifth aspect of the present disclosure, a data processing method executed in a center device capable of data communication with a vehicular device mounted on a vehicle is provided, wherein the vehicular device, based on detection data required for trigger condition determinations, performs the trigger condition determinations according to a combining way of trigger conditions, generates collection data based on determination results of the trigger condition determinations, and transmits the collection data to the center device. The data processing method comprises: generating the trigger conditions for detecting a given scene of the vehicle; generating the combining way of the trigger conditions; generating a collection data list corresponding to the trigger conditions; delivering the trigger conditions, the combining way, and the collection data list to the vehicular device; and acquiring the collection data from the vehicular device.

According to a sixth aspect of the present disclosure, a data processing method executed in a vehicular device mounted on a vehicle and capable of data communication with a center device is provided, wherein the center device generates trigger conditions for detecting a given scene of the vehicle, generates a combining way of the trigger conditions, generates a collection data list corresponding to the trigger conditions, delivers the trigger conditions, the combining way, and the collection data list to the vehicular device, and acquires collection data indicated in the collection data list from the vehicular device. The data processing method comprises: acquiring detection data required for trigger condition determinations; performing the trigger condition determinations based on the detection data according to the combining way of the trigger conditions; generating collection data based on determination results of the trigger condition determinations; and transmitting the collection data to the center device.

According to a seventh aspect of the present disclosure, a data processing program stored in a non-transitory storage medium for a center device capable of data communication with a vehicular device mounted on a vehicle is provided, wherein the vehicular device, based on detection data required for trigger condition determinations, performs the trigger condition determinations according to a combining way of trigger conditions, generates collection data based on determination results of the trigger condition determinations, and transmits the collection data to the center device. The data processing program causes a computer of the center device to execute: generating the trigger conditions for detecting a given scene of the vehicle; generating the combining way of the trigger conditions; generating a collection data list corresponding to the trigger conditions; delivering the trigger conditions, the combining way, and the collection data list to the vehicular device; and acquiring the collection data from the vehicular device.

According to an eighth aspect of the present disclosure, a data processing program stored in a non-transitory storage medium for a vehicular device mounted on a vehicle and capable of data communication with a center device is provided, wherein the center device generates trigger conditions for detecting a given scene of the vehicle, generates a combining way of the trigger conditions, generates a collection data list corresponding to the trigger conditions, delivers the trigger conditions, the combining way, and the collection data list to the vehicular device, and acquires collection data indicated in the collection data list from the vehicular device. The data processing program causes a computer of the vehicular device to execute: acquiring detection data required for trigger condition determinations; performing the trigger condition determinations based on the detection data according to the combining way of the trigger conditions; generating collection data based on determination results of the trigger condition determinations; and transmitting the collection data to the center device.

According to the above, the center device generates the combining way of the trigger conditions, and the vehicular device performs the trigger condition determinations based on the combining way and generates and transmits collection data to the center device based on results of the trigger condition determinations. It is possible to accurately generate a trigger condition for detecting a scene where users express dissatisfaction, and to facilitate managing trigger condition improvements and reuse.

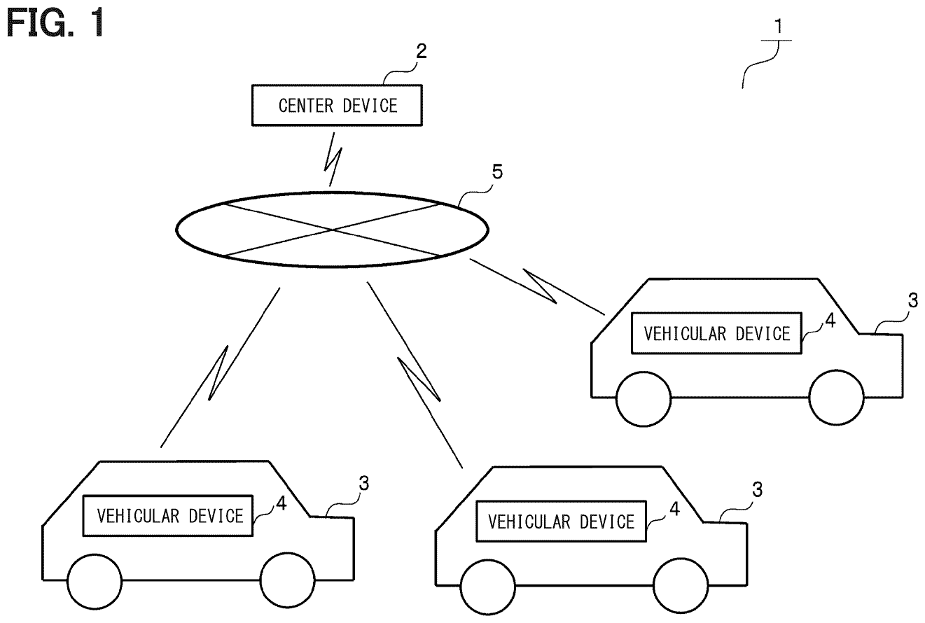

Hereinafter, embodiments will be described with reference to the drawings. As shown in FIG. 1, a data communication system 1 is configured such that vehicular devices 4 individually mounted on multiple vehicles 3 are capable of data communication with a center device 2 via a wide-area wireless communication network 5.

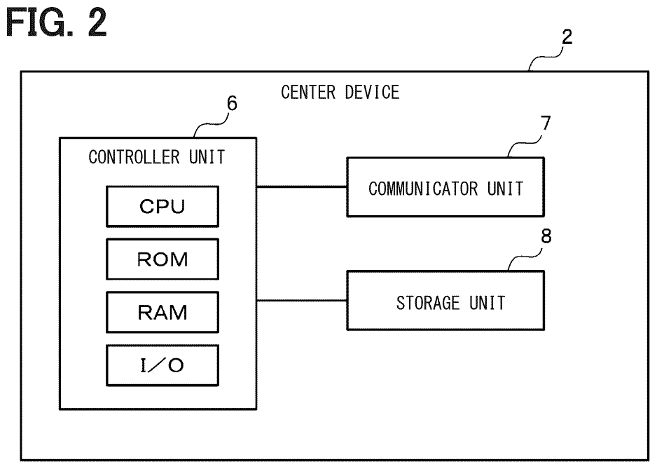

As shown in FIG. 2, the center device 2 includes a controller unit 6, a communicator unit 7, and a storage unit 8. The controller unit 6 includes, as its main component, a microcomputer (hereinafter referred to as a microcontroller) including a CPU, ROM, RAM, and I/O and executes controls via software processing by the CPU executing a computer program stored in a non-transitory tangible storage medium, and hardware processing by a dedicated electronic circuit, thereby controlling operations of the center device 2. A method corresponding to the computer program is executed by executing the computer program. The number of microcontrollers in the controller unit 6 may be one or more. The communicator unit 7 controls the data communication with the multiple vehicular devices 4 via the wide-area wireless communication network 5. The storage unit 8 stores various data.

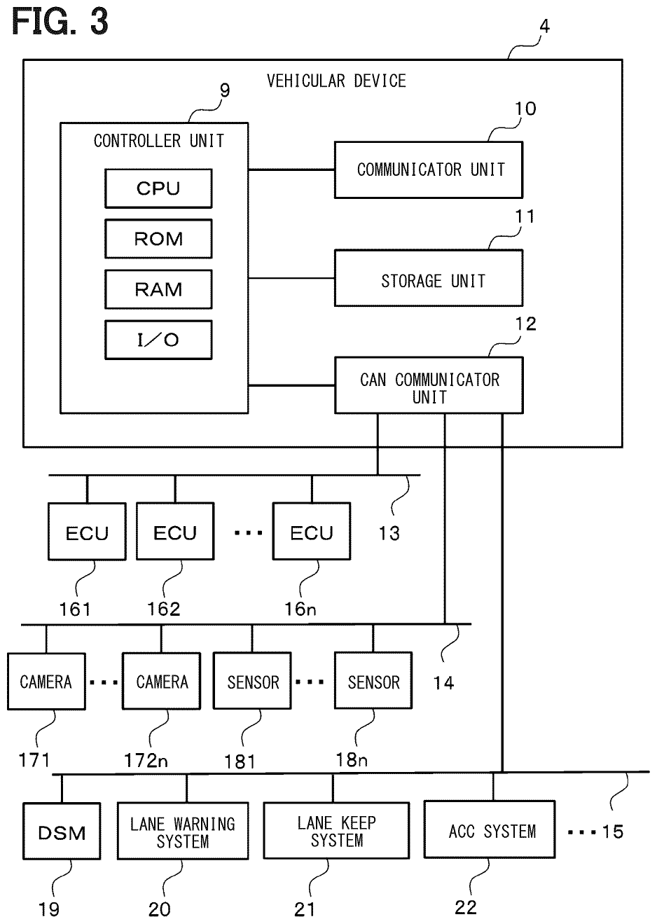

As shown in FIG. 3, the vehicular device 4 includes a controller unit 9, a communicator unit 10, a storage unit 11, and a CAN (Controller Area Network) communicator unit 12. The controller unit 9 includes, as its main component, a microcontroller including a CPU, ROM, RAM, and I/O, and executes controls via software processing by the CPU executing a computer program stored in a non-transitory tangible storage medium, and hardware processing by a dedicated electronic circuit, thereby controlling operations of the vehicular device 4. A method corresponding to the computer program is executed by executing the computer program. The number of microcontrollers in the controller unit 9 may be one or more. The communicator unit 10 controls the data communication with the center device 2 via the wide-area wireless communication network 5. The storage unit 11 stores various data.

The CAN communicator unit 12 connects to CAN buses 13 to 15. The CAN communicator unit 12 is connected so that the CAN communicator unit 12 can communicate with multiple ECUs 161 to 16n via the CAN bus 13. The multiple ECUs 161 to 16n include, for example, an engine ECU for engine control, an accelerator ECU for accelerator control, a brake ECU for brake control, a steering ECU for steering control, a meter ECU for meter control, and a navigation ECU for navigation control. For example, the accelerator ECU transmits data indicating throttle opening as the detection data to the CAN communicator unit 12. For example, the brake ECU transmits data indicating a brake pedal operation amount as the detection data to the CAN communicator unit 12. For example, the steering ECU transmits data indicating the angular velocity of steering wheel as the detection data to the CAN communicator unit 12. For example, the navigation ECU transmits data indicating the latitude and longitude as the detection data to the CAN communicator unit 12. ECUs of the multiple ECUs 161 to 16n are connected to the same single bus for each system. For example, ECUs for a ADAS (Advanced Driving Assistant System) are connected to a same single bus, ECUs for a body system are connected to a same single bus, ECUs for a chassis system are connected to a same single bus.

The CAN communicator unit 12 is connected via the CAN bus 14 to multiple cameras 171 to 17n and multiple sensors 181 to 18n in a data communicable manner. The multiple cameras 171 to 17n include, for example, a front camera for imaging an area forward of the vehicle, a vehicle inside camera for imaging an inside of the vehicle, and a driver camera for imaging the driver. For example, the front camera, which images the area forward of the vehicle, transmits data indicating the captured image of the area forward of the vehicle as the detection data to the CAN communicator unit 12. For example, the vehicle inside camera transmits data indicating the captured image of the vehicle inside as the detection data to the CAN communicator unit 12. The multiple sensors 181 to 18n include, for example, a LIDAR (Light Detection and Ranging, Laser Imaging), a millimeter-wave radar, an ultrasonic sensor, an illuminance sensor, a rain sensor, etc. For example, the sensor detecting an area forward of the vehicle, such as the LIDAR or the millimeter-wave radar, transmits data indicating a distance to a preceding vehicle as the detection data to the CAN communicator unit 12. For example, the illuminance sensor transmits data indicating illuminance as the detection data to the CAN communicator unit 12. For example, the rain sensor transmits data indicating a rainfall amount as the detection data to the CAN communicator unit 12.

The CAN communicator unit 12 is connected via the CAN bus 15 to a DSM (Driver Status Monitor) 19, a lane warning system 20, a lane keep system 21, an ACC (Adaptive Cruise Control) system 22, and other systems in a data communicable manner. For example, the DSM 19 transmits data indicating a driver's status as the detection data to the CAN communicator unit 12. For example, the lane warning system 20 transmits data indicating a control status of the lane warning system 20 as the detection data to the CAN communicator unit 12. For example, the lane keep system 21 transmits data indicating a control status of the lane keep system 21 as the detection data to the CAN communicator unit 12. For example, the ACC system 22 transmits data indicating a control status of the ACC system 22 as the detection data to the CAN communicator unit 12.

The number of CAN buses 13 to 15 connected to the CAN communicator unit 12 is not limited to three; it may be two or less, or four or more. A form in which various ECUs 161 to 16n, various cameras 171 to 17n, various sensors 181 to 18n, the DSM 19, and various systems 20 to 22 are connected to the CAN buses 13 to 15 may be any form. Various devices connected to the CAN bus 13 to 15 are not limited to the ECUs, the cameras, the sensors, and the systems described above. Furthermore, an in-vehicle communication network used is not limited to the CAN buses 13 to 15 but may be a configuration using Ethernet, etc. Ethernet is a registered trademark.

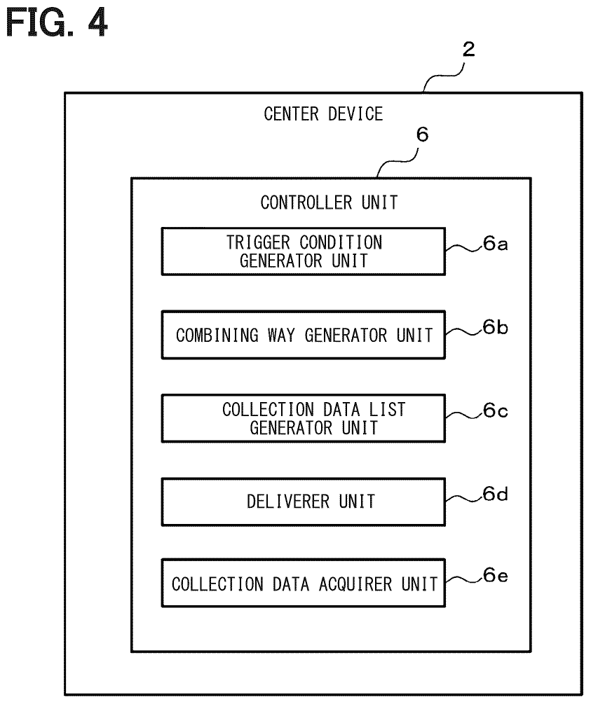

As shown in FIG. 4, on a function basis, the controller unit 6 in the center device 2 includes a trigger condition generator unit 6a, a combining way generator unit 6b, a collection data list generator unit 6c, a deliverer unit 6d, and a collection data acquirer unit 6e. These units 6a to 6e execute a data processing method of the center device 2 and execute a data processing program of the center device 2.

The trigger condition generator unit 6a generates a plurality of trigger conditions for detecting a scene where the user feels dissatisfied (corresponding to a given scene of the vehicle). The combining way generator unit 6b generates a combining way of the trigger conditions. The collection data list generator unit 6c generates a collection data list corresponding to the plurality of trigger conditions. The deliverer unit 6d causes the communicator unit 7 to deliver the trigger conditions generated by the trigger condition generator unit 6a, the combining way generated by the combining way generator unit 6b, and the collection data list generated by the collection data list generator unit 6c to the vehicular device 4. The data acquirer unit 6e acquires the collection data from the vehicular device 4 by receiving at the communicator unit 7 the collection data transmitted from the vehicular device 4.

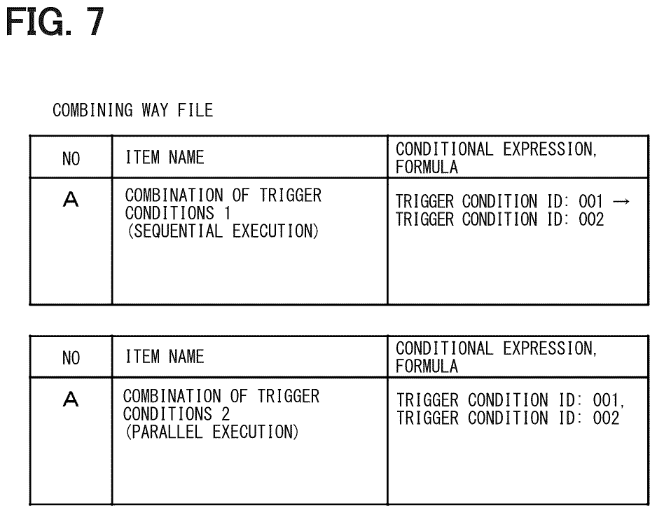

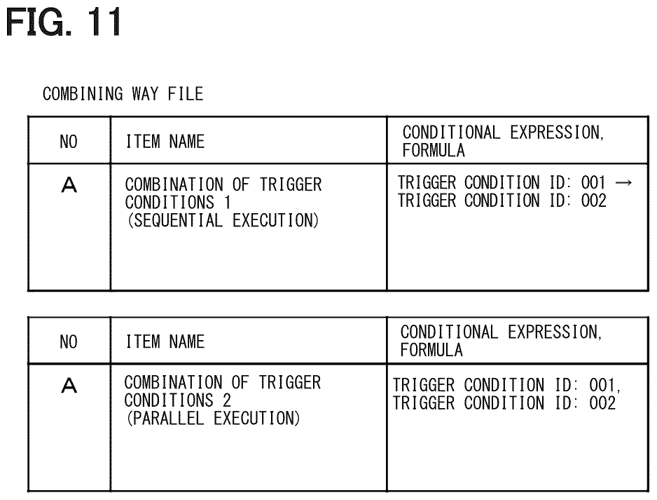

In the center device 2, the controller unit 6 may further include a trigger condition manager unit. The trigger condition manager unit assigns and manages a unique trigger condition ID to each trigger condition generated by the trigger condition generator unit 6a. For example, in a non-volatile memory, the trigger condition manager unit stores trigger condition management information in which each trigger condition and its trigger condition ID are linked to each other. The controller unit 6 may further include a combining way manager unit. The combining way manager unit manages and assigns a unique combining way ID to the combining way of the trigger conditions generated by the combining way generator unit 6b. In a non-volatile memory, the combining way manager unit stores combining way management information in which the trigger conditions and the combining way ID are linked to each other. In the combining way management information, the combining way of the trigger conditions may be expressed using trigger condition IDs. For example, it may be expressed as a conditional expression or a calculation formula, such as those illustrated in FIGS. 7 and 11 described later. In the combining way management information, the combining way of the trigger conditions may be linked to a collection data list ID for identifying the collection data list delivered together with the combining way. When generating a combining way of trigger conditions, the combining way generator unit 6b may modify the combining way of trigger conditions contained in the combining way management information, thereby generating a new combining way.

The combining way of trigger conditions will be described. There are two cases for the combining ways of trigger conditions. One is a case where a return value is returned. The other is a case where no return value is returned. Respective cases will be described below.

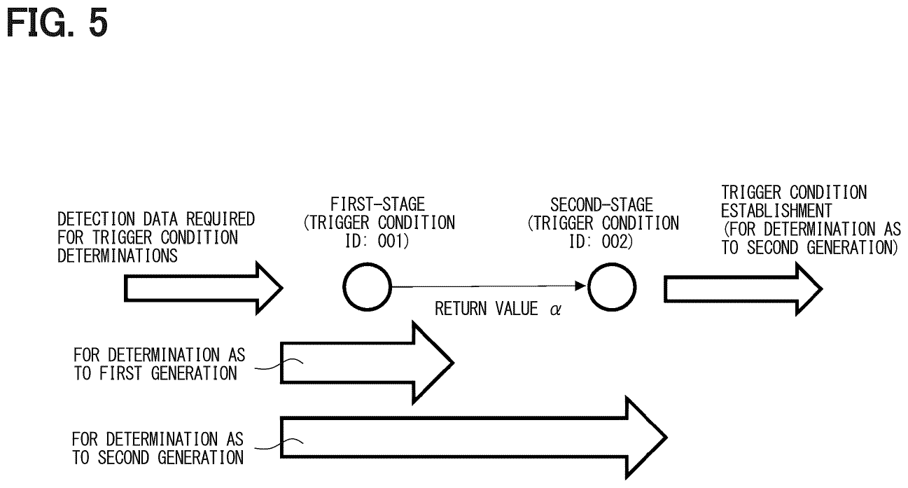

### (1) Case Where Return Value is Returned (see FIGS. 5 to 8)

As shown in FIG. 5, the case where the return value is returned is, for example, such that: the first stage is a trigger condition determination for the ADAS system of the first generation; the second stage is an additional determination as to a trigger condition for the ADAS system of the second generation and the second stage is set so that the second stage determination is made upon establishment of the first stage trigger condition; and upon establishment of the second stage trigger condition, the collection data is generated. The following examples illustrate the trigger condition IDs, the combining way of trigger conditions, and the collection data. The driver ID is a driver identifier for identifying the driver.

“Trigger Condition ID: 001”,
the control status of the lane warning system: in operation,
the deviation value from the lane center: ≥10 cm (the return value α of ab intermediate parameter during a calculation process),
the steering wheel angular velocity made from the user: ≥(10×β) dps (adjusted by multiplying by an adjustment coefficient β corresponding to the driver ID),

“Trigger Condition ID: 002”,
the control status of the lane keep system: in operation,
the calculation result using the return value α: ≥10 cm,
the steering wheel angular velocity made from the user: ≥(10×β) dps (adjusted by multiplying by an adjustment coefficient β corresponding to the driver ID),

“Combining way of trigger conditions”,
Trigger Condition ID: 001→Trigger Condition ID: 002,

“Collection data”,
from 60 seconds before the trigger condition establishment, the control status of the lane warning system, the control status of the lane keep system, the latitude and the longitude, the deviation value from the lane center, the steering wheel angular velocity made from the user.

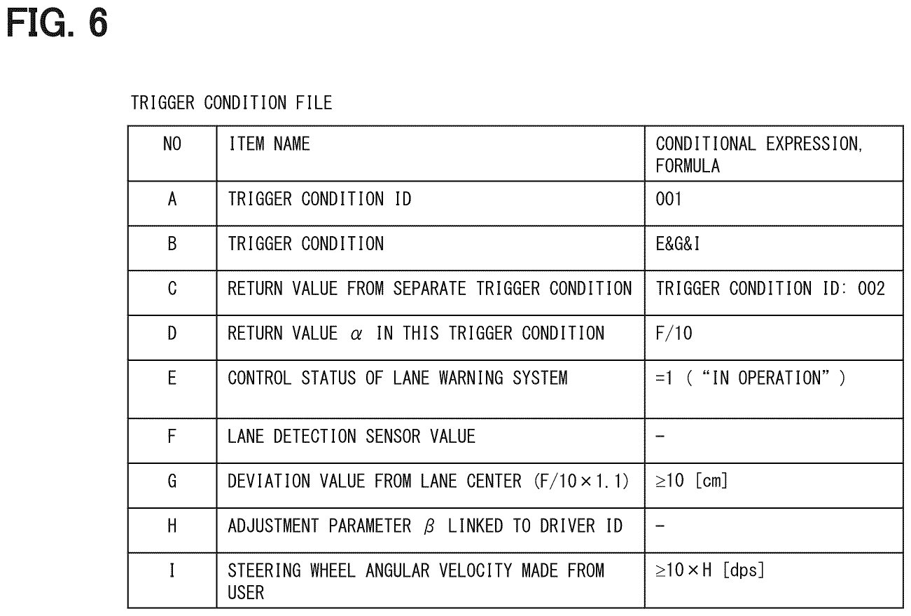

The trigger condition generator unit 6a generates a trigger condition file and generates the trigger conditions, as shown in FIG. 6. The trigger condition file illustrated in FIG. 6 includes the following items: the trigger condition ID, the trigger condition, the return value from a separate trigger condition, the return value α in this trigger condition, the control status of the lane warning system, the lane detection sensor value, the deviation value from the lane center (F/10×1.1), the adjustment parameter β linked to the driver ID, and the steering wheel angular velocity made from the user. In FIG. 6, the definition of the return value is given, and the trigger condition determination for “Trigger Condition ID: 001” and the trigger condition determination for “Trigger Condition ID: 002” have a dependent relationship. The return value in the trigger condition determination for “Trigger Condition ID: 001” is passed to the trigger condition determination for “Trigger Condition ID: 002”.

The adjustment parameter β linked to the driver ID may be set, for example, by the following program description:
if (driver ID==“00001”)
{β=1.5;}
   {
   else
{β=1.0;
   }

For drivers who tend to prefer spirited driving, the steering wheel angular velocity for cancelling the lane keep system is set so as be higher than a standard value. For typical drivers, this steering wheel angular velocity is set to the standard value. A threshold and/or a model for recognition is adjusted based on the driver ID.

The combining way generator unit 6b generates the combining way of trigger conditions. The combining way generator unit 6b generates a combining way file and generates the combining way of trigger conditions, as shown in FIG. 7. Items of the combining way file illustrated in FIG. 7 include sequential execution (corresponding to performing trigger condition determinations in series) and parallel execution (corresponding to performing trigger condition determinations in parallel). Note that in the case of the parallel execution, the trigger condition determination for a trigger condition to which a return value is passed from a separate trigger condition is waited until the return value is passed from the trigger condition.

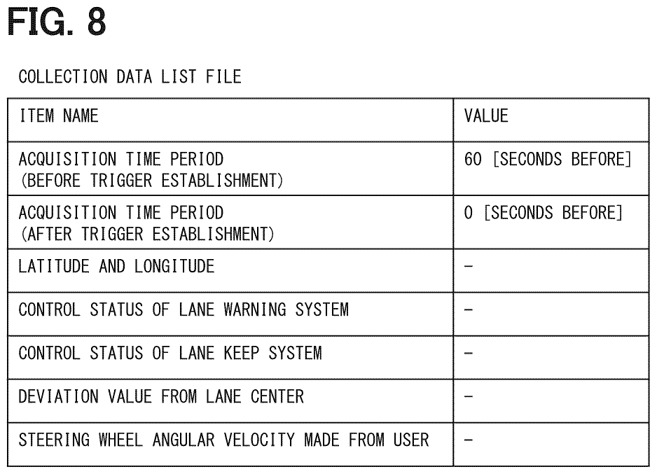

The collection data list generator unit 6c generates the collection data list corresponding to the plurality of trigger conditions. The collection data list generator unit 6c generates a collection data list file for generating the collection data, as shown in FIG. 8. The collection data list file shown in FIG. 8 includes the following items: an acquisition time period (before the trigger establishment), an acquisition time period (after the trigger establishment), the latitude and longitude, the control status of the lane warning system, the control status of the lane keep system, the deviation value from the lane center, and the steering angle input from the user.

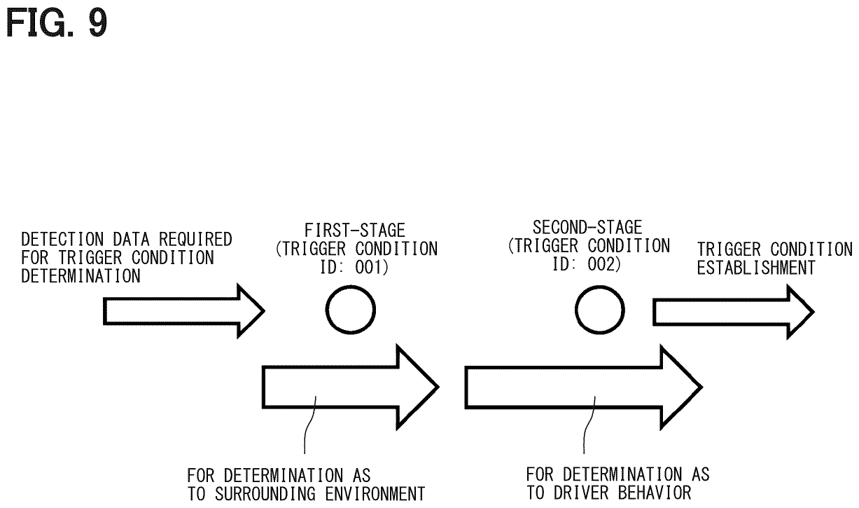

### (2) Case Where no Return Value is Returned (see FIGS. 9 to 12)

As shown in FIG. 9, an example of the case where no return value is returned is such that the first stage is a determination as to a surrounding environment and the second stage is a determination as to the driver behavior and the collection data is generated upon meeting both the first stage and the second stage. The following examples illustrate the trigger condition IDs, the combining way of trigger conditions, and the collection data.

“Trigger Condition ID: 001”,
Illuminance sensor: ≥40,000 lux,
Rain sensor: ≤1 mm/h,

“Trigger Condition ID: 002”,
Headlight status: 1 (low beam),
brake pedal travel: ≥(10 ×β) cm (Adjusted by multiplying the driver ID-specific adjustment coefficient β),

“Combining way of trigger conditions”,
trigger Condition ID: 001→Trigger Condition ID: 002,

“Collection data”,
from 60 seconds prior to trigger condition establishment, the Latitude and longitude, the vehicle speed, the light sensor, the rain sensor, the headlight status, and the brake pedal operation amount.

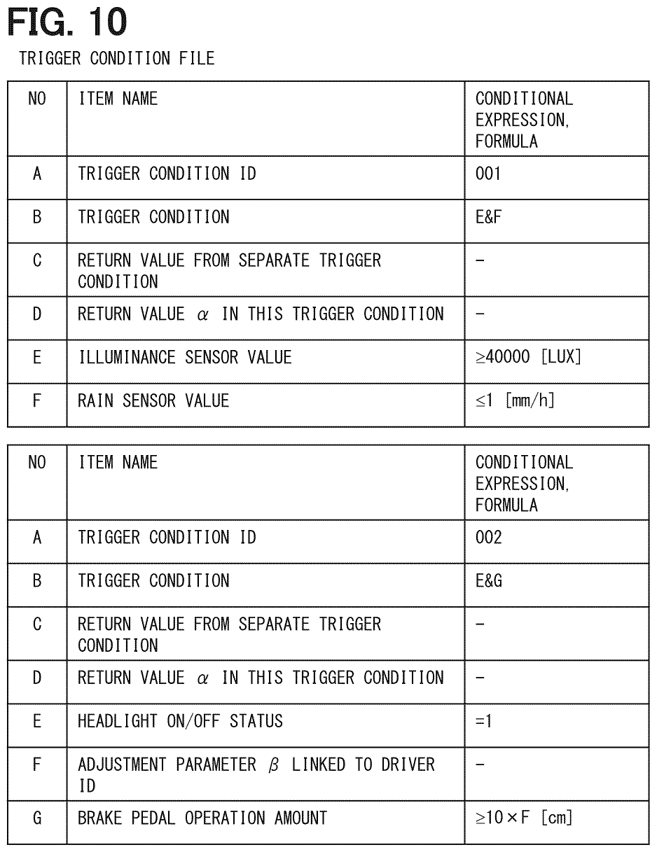

The trigger condition generator unit 6a generates a trigger condition file and generates the trigger conditions, as shown in FIG. 10. The trigger condition file illustrated in FIG. 10 has two groups: one including the trigger condition ID, the trigger condition, the return value from a separate trigger condition, the return value α in this trigger condition, the illuminance sensor value, and the rain sensor value; and the other including the trigger condition ID, the trigger condition, the return value from a separate trigger condition, the return value α in this trigger condition, the headlight on/off status, the adjustment parameter β linked to driver ID, and the brake pedal operation amount. In FIG. 10, the definition of the return value is not given, and the trigger condition determination for “Trigger Condition ID: 001” is independent of the trigger condition determination for “Trigger Condition ID: 002”. The return value in the trigger condition determination for “Trigger Condition ID: 001” is not passed to the trigger condition determination for “Trigger Condition ID: 002”. In this case, the trigger condition determinations are performed separately for each data type such that the determination as to the surrounding environment is performed in the first stage and the determination as to the driver's behavior is performed in the second stage.

In this case as well, the adjustment parameter β linked to the driver ID can be set, for example, by writing the following program description.

if (driver ID==“00001”)

{β=1.5;}

{
else
{β=1.0;}
   {

The combining way generator unit 6b generates the combining way of trigger conditions. The combining way generator unit 6b generates a combining way file and generates the combining way of trigger conditions, as shown in FIG. 11. Items of the combining way file illustrated in FIG. 11 include sequential execution (corresponding to performing trigger condition determinations in series) and parallel execution (corresponding to performing trigger condition determinations in parallel).

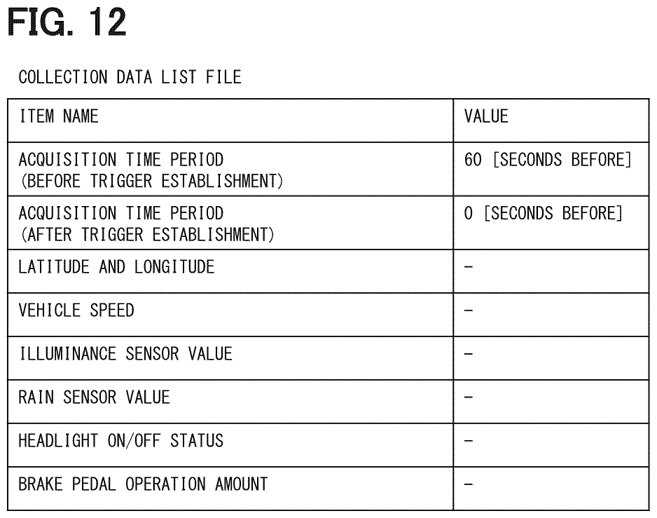

The collection data list generator unit 6c generates the collection data list corresponding to the plurality of trigger conditions. The collection data list generator unit 6c generates a collection data list file for generating the collection data, as shown in FIG. 12. Items of the collection data list file shown in FIG. 12 include acquisition time period (before trigger establishment), acquisition time period (after trigger establishment), the latitude and longitude, vehicle speed, illuminance sensor value, rain sensor value, headlight on/off status, and brake pedal operation amount.

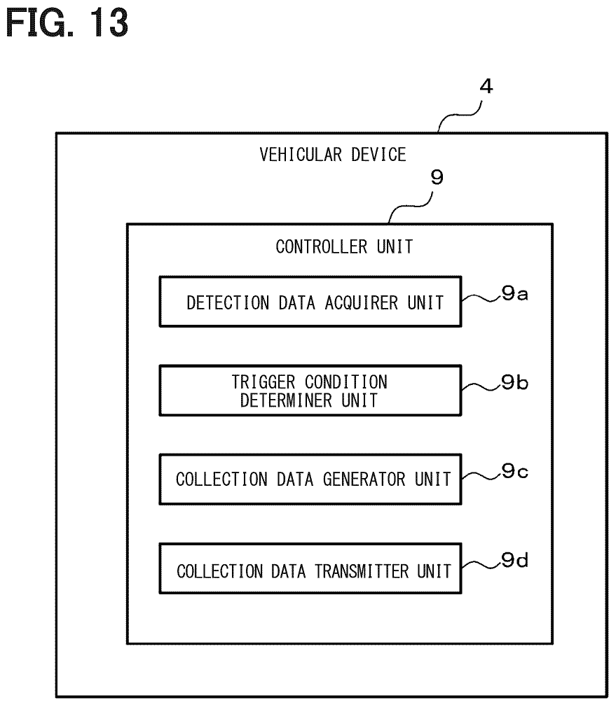

As shown in FIG. 13, on a function basis, the controller unit 9 in the vehicular device 4 includes a detection data acquirer unit 9a, a trigger condition determiner unit 9b, a collection data generator unit 9c, and a collection data transmitter unit 9d. These units 9a to 9d execute a data processing method for the vehicular device 4 and execute a data processing program for the vehicular device 4.

The detection data acquirer unit 9a acquires detection data required for trigger condition determinations. For determining the control status of the lane warning system 20 for example, the detection data acquirer unit 9a acquires the data indicating the control status of the lane warning system 20 as the detection data from the lane warning system 20. For determining the steering wheel angular velocity made from the user for example, the detection data acquirer unit 9a acquires the data indicating the steering wheel angular velocity made from the user as the detection data. For determining the illuminance sensor value for example, the detection data acquirer unit 9a acquires the data indicating illuminance from the illuminance sensor as the detection data. For determining the rain sensor value for example, the detection data acquirer unit 9a acquires the data indicating a rainfall amount from the rain sensor as the detection data.

When the detection data is acquired by the detection data acquirer unit 9a, the trigger condition determiner unit 9b performs the trigger condition determinations based on the acquired detection data according to the combining way of the trigger conditions. The data collector unit 9c generates the collection data based on determination results of the trigger condition determinations. The collection data transmitter unit 9d transmits the collection data generated by the collection data generator unit 9c from the communicator unit 10 to the center device 2.

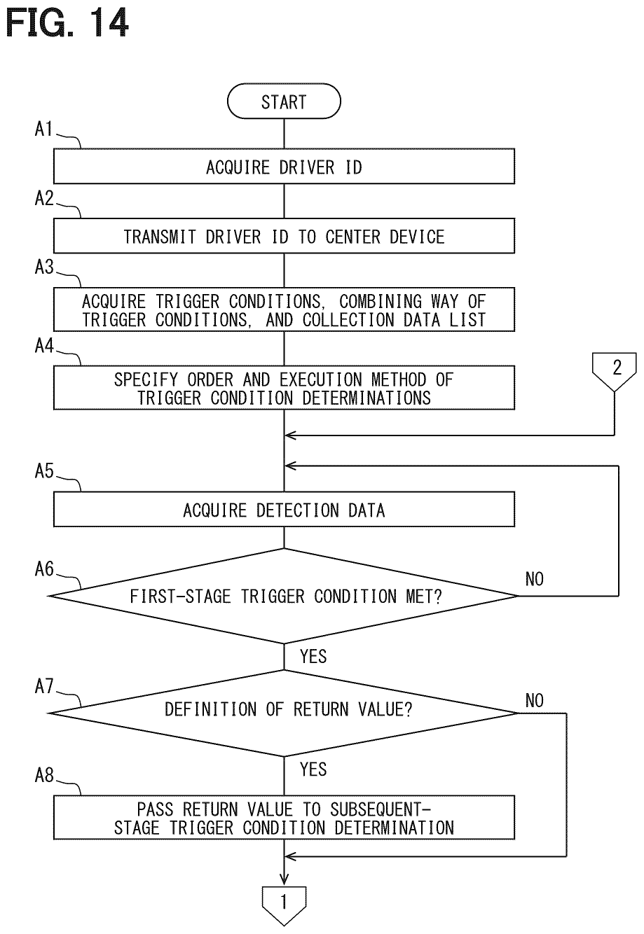

The operation in the above configuration will be described with reference to FIGS. 14 to 17. A. The process performed by the controller unit 9 of the vehicular device 4 and the process performed by the controller unit 6 of the center device 2 will be described.

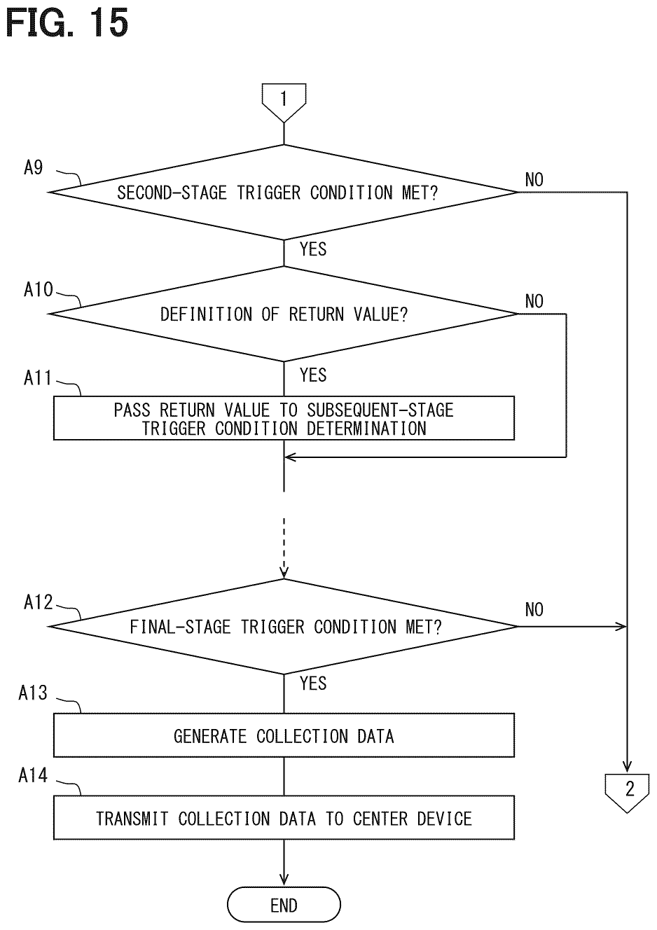

### (1) Process Performed by Controller Unit 9 of Vehicular Device 4 (see FIGS. 14 to 15)

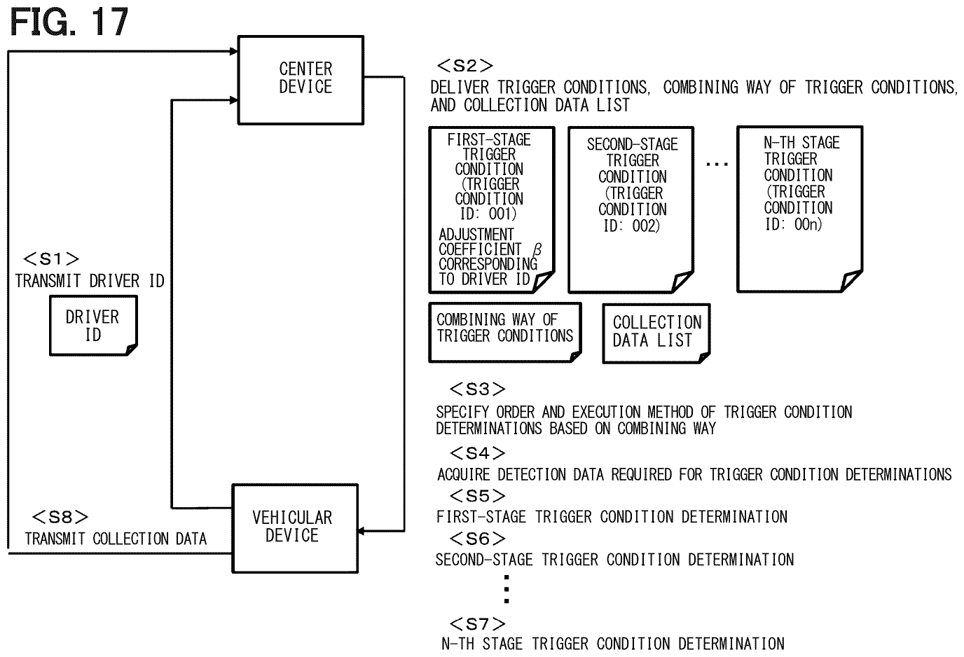

In the vehicular device 4, the controller unit 9 starts a vehicle-side process and in response to detecting a user boarding (A1), acquires the driver ID unique to the user onboard (A1). The controller unit 9 transmits the acquired driver ID from the communicator unit 10 to the center device 2 (A2, S1 shown in FIG. 17) and waits to receive the trigger conditions, the combining way of the trigger conditions, and the collection data list from the center device 2.

The controller unit 9 acquires the trigger conditions, the combining way of the trigger conditions, and the collection data list from the center device 2 (A3) upon receiving the trigger conditions, the combining way of the trigger conditions, and the collection data list from the center device 2 via the communicator unit 10 and then specifies the order in which the trigger condition determinations are to be performed and execution methods of the trigger condition determinations, based on the acquired combining way of the trigger conditions (A4, S3 shown in FIG. 17).

Upon specifying the trigger condition determination order and the execution methods, the controller unit 9 acquires the detection data required for the trigger condition determinations based on the combining way (A5, corresponding to step S4 in FIG. 17, and a detection data acquisition procedure). The controller unit 9 determines whether the first-stage trigger condition is met (A6, corresponding to S5 in FIG. 17 and a trigger condition determination procedure). If the controller unit 6 determines that the first-stage trigger condition is met (A6: YES), then the controller unit 6 determines whether the definition of the return value is given (A7).

If the controller unit 9 determines that the definition of the return value is given (A7: YES), the controller unit 9 then passes the return value from the first-stage trigger condition determination to the second-stage trigger condition determination (A8) and determines whether the second-stage trigger condition is met (A9, corresponding to S6 shown in FIG. 17 and a trigger condition determination procedure). If the controller unit 9 determines that the definition of the return value is not given (A7: NO), the controller unit 9 then determines whether the second-stage trigger condition is met (A9, corresponding to step S6 shown in FIG. 17 and a trigger condition determination procedure).

If the controller unit 6 determines that the second-stage trigger condition is met (A9: YES), the controller unit 6 then determines whether the definition of the return value is given as described above and repeats the same process until the final-stage trigger condition determination is performed (A10 to A12, S7 shown in FIG. 17). If the controller unit 9 determines that the trigger condition determination in the final stage is met (A12: YES), the controller unit 9 then generates the collection data (A13, corresponding to a collection data generation procedure), transmits the generated collection data from the communicator unit 10 to the center device 2 (A14, corresponding to a collection data transmission procedure), and end the vehicle-side process.

In the trigger condition determination in the case where “the return value is returned, the controller unit 9 determines that the first-stage trigger condition is met if the following is met for “Trigger Condition ID: 001”,
the control status of the lane warning system: in operation,
the deviation value from the lane center: ≥10 cm (the return value α of the intermediate parameter during the calculation process), and
the steering wheel angular velocity made from the user: ≥(10×β) dps (adjusted by multiplying by the adjustment coefficient β corresponding to the driver ID).

Specifically, the controller unit 9 determines that the first-stage trigger condition is met if: the lane warning system is in operation; the deviation from the lane center is 10 cm or greater; and the user performs a steering operation with the steering wheel angular velocity of (10×β) dps or greater. If the controller unit 9 determines that the first-stage trigger condition is met, the controller unit 9 then passes the return value α as the intermediate parameter in the calculation to the second-stage trigger condition determination.

After the controller unit 9 passes the return value α to the second-stage trigger condition determination, the controller unit 9 determines that the second-stage trigger condition is met if the following is met for “Trigger Condition ID: 002”,
the control status of the lane keep system: in operation,
the calculation result using the return value α: ≥10 cm, and
the steering wheel angular velocity made from the user: ≥(10×β) dps (adjusted by multiplying by adjustment coefficient β corresponding to driver ID).

Specifically, the controller unit 9 determines that the second-stage trigger condition is met if: the lane keep system is in operation; the deviation from the lane center is 10 cm or greater; and the user performs a steering operation with the steering wheel angular velocity of (10×β) dps or greater.

Because the combining way of trigger conditions is “Trigger Condition ID: 001→Trigger Condition ID: 002” and the second-stage trigger condition determination corresponds to the final-stage trigger condition determination, the controller unit 9 generates the collection data and the transmits the generated collection data from the communicator unit 10 to the center device2, wherein the collection data includes the data from 60 seconds before the trigger condition establishment, including: the control status of the lane warning system; the control status of the lane keep system; the latitude and longitude; the deviation value from the lane center; and the steering wheel angular velocity made from the user. Specifically, upon meeting the first-stage trigger condition and then meeting the second-stage trigger condition, the controller unit 9 transmits the data before and after the user feels dissatisfied to the center device 2, the data including: the control status of the lane warning system; the control status of the lane keep system; the latitude and the longitude; the deviation value from the lane center; and the steering wheel angular velocity input from the user.

In the trigger condition determination in the case where the return value is not returned, the controller unit 9 determines that the first-stage trigger condition is met if the following is met for “Trigger Condition ID: 001”,
the illuminance sensor value: ≥40,000 lux; and
the rain sensor value: ≤1 mm/h.

Specifically, the controller unit 9 determines that the first-stage trigger condition is met if: the illuminance sensor value is 40,000 lux or higher; and the rain sensor value is 1 mm/h or lower.

The controller unit 9 determines that the second-stage trigger condition is met if the following is met for “Trigger condition ID: 002”,
the headlight status: 1 (low beam), and
the brake pedal operation amount ≥(10 ×β) cm (Adjusted by multiplying the driver ID-specific adjustment coefficient β).

Specifically, the controller unit 9 determines that the second-stage trigger condition is met if: the illuminance sensor value indicates the headlights are on (low beam); and the user applies the brakes with the brake pedal operation amount of (10 ×β) cm or more.

Because the combining way of trigger conditions is “Trigger Condition ID: 001→Trigger Condition ID: 002,” and the second-stage trigger condition determination corresponds to the final-stage trigger condition determination, the controller unit 9 generates the collection data and transmits the generated collection data from the communicator unit 10 to the center device 2, wherein the collection data is the data from 60 seconds before the trigger condition establishment and includes the rain sensor value, the headlight on/off status, and the brake pedal operation amount. Specifically, upon meeting the first-stage trigger condition and then meeting the second-stage trigger condition, the controller unit 9 transmits the data before and after the driver feels dissatisfied to the center device 2, the data including the latitude and longitude, the vehicle speed, the illuminance sensor value, the rain sensor value, the headlight on/off status, and the brake pedal operation amount.

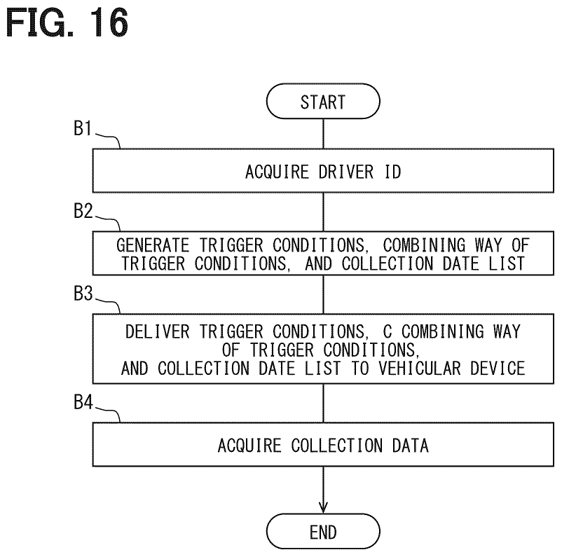

### (2) Process Performed by Controller Unit 6 of Center Device 2 (see FIG. 16)

Upon starting the center-side process in the center device 2, the controller unit 6 acquires the driver ID received at the communicator unit 7 from the center device 2 (B1) and then generates the plurality of trigger conditions, the combining way of the trigger conditions, and the collection data list (B2, corresponding to a trigger condition generation procedure, a combining way generation procedure, and a collection data list generation procedure). The controller unit 6 causes the communicator unit 7 to deliver the generated trigger conditions, the combining ways of the trigger conditions, and the collection data list to the vehicular device 4 (B3, S2 shown in FIG. 17) and waits to receive the collection data from the vehicular device 4.

The controller unit 6 acquires the collection data transmitted from the vehicular device 4 and received at the communicator unit 10 (B4, corresponding to a collection data acquisition procedure) and ends the center-side process. After that, the collection data acquired from the vehicular device 4 can be analyzed and thereby the scene where the user feels dissatisfied can be analyzed.

The above illustrates utilizing the driver ID and generating the trigger condition file including the adjustment parameter linked to the driver ID. Alternatively the driver ID may not be utilized and the trigger condition file not including the adjustment parameter linked to the driver ID may be generated.

The above-described embodiment provides the following operational effects. The center device 2 generates the combining way of the trigger conditions. The vehicular device 4 performs the plurality of trigger condition determinations based on the combining way, generates the collection data based on results of these determinations and transmits the collection data to the center device 2. It is possible to accurately generate trigger conditions for detecting a scene where the user feels dissatisfaction, and to facilitate managing trigger condition improvements and reuse. The center device 2 selects whether to use a respective trigger condition and performs fine-tuning of each trigger condition based upon which combination of trigger conditions was establishment and upon the collection data at that time, whereby it is possible to generate the trigger conditions with high accuracy. The center device 2 manages each trigger condition with the trigger condition ID, whereby it is possible to easily manage trigger condition improvements and reuse.

The trigger condition determinations are performed in multiple stages and a result given in the preceding-stage trigger condition determination is passed as a return value to the subsequent-stage trigger condition determination. When the trigger condition determination in the preceding stage and that in the subsequent stage have a relatively high relationship, the result given in the preceding stage trigger condition determination can be reflected in the subsequent stage trigger condition determination. It is possible to accurately generate trigger conditions and to easily manage trigger condition improvements and reuse.

The trigger condition determinations are performed in multiple stages and no result given in the preceding-stage trigger condition determination is passed as a return value to the subsequent-stage trigger condition determination. When the trigger condition determination in the preceding stage and that in the subsequent stage have a relatively low relationship, the determination result in the preceding stage trigger condition determination can be treated as being independent of the subsequent stage trigger condition determination. It is possible to accurately generate trigger conditions and to easily manage trigger condition improvements and reuse.

The trigger condition is generated based on the driver ID. By incorporating driver preferences and characteristics into trigger conditions, it is possible to easily manage trigger condition combination improvement and respective trigger conditions reuse including driver preferences and characteristics.

Although the present disclosure has been described in accordance with embodiments, it is to be understood that the present disclosure is not limited to the embodiments or structures. The present disclosure encompasses various modifications and variations within equivalent ranges. Additionally, various combinations and configurations as well as other combinations and configurations, including only one element, more, or less, are within the scope and spirit of the present disclosure.

The controller units and methods described in the present disclosure may be implemented by one or more special purpose computers provided by configuring a memory and a processor programmed to execute one or more functions embodied in a computer program. Alternatively, the controller units and methods described in the present disclosure may be implemented by one or more special purpose computers provided by configuring a processor with one or more dedicated hardware logic circuits. Alternatively, the controller units and methods described in the present disclosure may be implemented by one or more special purpose computers provided by configuring (i) a memory and a processor programmed to perform one or more functions in combination with (ii) one or more hardware logic circuits. The computer program may be stored in a computer-readable non-transitory tangible storage medium as instructions to be executed by a computer.

In addition to claims, the present disclosure encompasses the following.
[1]. A data communication system (1) comprises:
a center device (2) and a vehicular device (4) mounted on a vehicle which are capable of data communication with each other,
the center device including:
a trigger condition generator unit (6a) that generates trigger conditions for detecting a given scene of the vehicle;
a combining way generator unit (6b) that generates a combining way of the trigger conditions;
a collection data list generator unit (6c) that generates a collection data list corresponding to the trigger conditions;
a deliverer unit (6d) that delivers the trigger conditions, the combining way, and the collection data list to the vehicular device; and
a collection data acquirer unit (6e) that acquires collection data indicated in the collection data list from the vehicular device,
the vehicular device including:
a detection data acquirer unit (9a) that acquires detection data required for trigger condition determinations;
a trigger condition determiner unit (9b) that performs the trigger condition determinations based on the detection data according to the combining way of the trigger conditions;
a data collector unit (9c) that generates the collection data based on determination results of the trigger condition determinations; and
a collection data transmitter unit (9d) that transmits the collection data to the center device.
[2]. In the data communication system according to [1],
the trigger condition determiner unit performs the trigger condition determinations in multiple stages.
[3]. In the data communication system according to [2],
the trigger condition determiner unit passes a determination result in a preceding-stage determination among the trigger condition determinations as a return value to a subsequent-stage determination among the trigger condition determinations.
[4]. In the data communication system according to [2],
the trigger condition determiner unit does not pass a determination result in a preceding-stage determination among the trigger condition determinations as a return value to a subsequent-stage determination among the trigger condition determinations.
[5]. In the data communication system according to any one of [2] to [4],
the trigger condition determiner unit performs the trigger condition determinations in series.
[6]. In the data communication system according to any one of [2] to [4],
the trigger condition determiner unit performs the trigger condition determinations in parallel.
[7]. In the data communication system according to any one of [1] to [6],
the trigger condition generator unit generates the trigger conditions based on driver identification information which identifies a driver.
[8]. In the data communication system according to any one of [1] to [7],
the detection data acquirer unit acquires the detection data based on the combining way.
[9]. In the data communication system according to any one of [1] to [8],
the trigger condition determiner unit performs the trigger condition determinations separately for each data type.

What is claimed is:

1. A data communication system comprising:
a center device and a vehicular device mounted on a vehicle which are capable of data communication with each other,
the center device including at least one computer, including a processor that executes a program and/or a dedicated circuit, implementing:
a trigger condition generator that generates trigger conditions for detecting a given scene of the vehicle;
a combining way generator that generates a combining way of the trigger conditions;
a collection data list generator that generates a collection data list corresponding to the trigger conditions;
a deliverer that delivers the trigger conditions, the combining way, and the collection data list to the vehicular device; and
a collection data acquirer that acquires collection data indicated in the collection data list from the vehicular device,
the vehicular device including at least one computer, including a processor that executes a program and/or a dedicated circuit, implementing:
a detection data acquirer that acquires detection data required for trigger condition determinations;
a trigger condition determiner that performs the trigger condition determinations based on the detection data according to the combining way of the trigger conditions;
a data collector that generates the collection data based on determination results of the trigger condition determinations; and
a collection data transmitter that transmits the collection data to the center device.

2. The data communication system according to claim 1, wherein:
the combining way designates an order in which the trigger condition determinations are to be performed; and
the trigger condition determiner performs the trigger condition determinations in an order based on the combining way received from the center device.

3. The data communication system according to claim 1, wherein:
the combining way designates whether the trigger condition determinations are to be performed in series or in parallel; and
the trigger condition determiner performs the trigger condition determinations in a manner based on the combining way received from the center device.

4. The data communication system according to claim 1, wherein:
the trigger conditions include a first trigger condition and a second trigger condition;
the first trigger condition includes a calculation value of a given item meeting a given conditional expression; and
when the second trigger condition includes a conditional expression using the calculation value of the given item calculated for the first trigger condition, the trigger condition determiner uses the calculation value as a return value to determine whether the second trigger condition is met.

5. The data communication system according to claim 1, wherein:
each of the trigger conditions is a combination of conditional expressions regarding given items; and
the combining way generator designates the combination per trigger condition.

6. The data communication system according to claim 1, wherein:
each of the trigger conditions is a combination of conditional expressions regarding given items; and
per trigger condition, the combining way generator designates the combination and a determination order.

7. The data communication system according to claim 1, wherein:
the trigger conditions for detecting the given scene are the trigger conditions for detecting user dissatisfaction with an operation of a vehicle functionality.

8. The data communication system according to claim 1, wherein:
the trigger conditions for detecting the given scene are the trigger conditions for detecting user dissatisfaction with an operation of a vehicle functionality; and
at least one of the trigger conditions is a condition relating to driver behavior.

9. The data communication system according to claim 1, wherein:
the trigger conditions for detecting the given scene are the trigger conditions for detecting user dissatisfaction with an operation of a vehicle functionality; and
the trigger conditions include a condition relating to an environment and a condition relating to driver behavior.

10. The data communication system according to claim 1, wherein:
the trigger condition generator generates the trigger conditions based on a driver identifier information which identifies a driver.

11. The data communication system according to claim 1, wherein:
the trigger condition generator generates the trigger conditions based on a driver characteristic.

12. The data communication system according to claim 1, wherein: depending on the trigger conditions to be determined based on the combining way, the detection data acquirer changes the detection data to be acquired.

13. A center device capable of data communication with a vehicular device mounted on a vehicle, wherein the vehicular device, based on detection data required for trigger condition determinations, performs the trigger condition determinations according to a combining way of trigger conditions, generates collection data based on determination results of the trigger condition determinations, and transmits the collection data to the center device,
the center device comprising at least one computer, including a processor that executes a program and/or a dedicated circuit, implementing:
a trigger condition generator that generates trigger conditions for detecting a given scene of the vehicle;
a combining way generator that generates a combining way of the trigger conditions;
a collection data list generator that generates a collection data list corresponding to the trigger conditions;
a deliverer that delivers the trigger conditions, the combining way, and the collection data list to the vehicular device; and
a data acquirer that acquires the collection data from the vehicular device.

14. A vehicular device mounted on a vehicle and capable of data communication with a center device wherein the center device generates trigger conditions for detecting a given scene of the vehicle, generates a combining way of the trigger conditions, generates a collection data list corresponding to the trigger conditions, delivers the trigger conditions, the combining way, and the collection data list to the vehicular device, and acquires collection data from the vehicular device,
the vehicular device comprising at least one computer, including a processor that executes a program and/or a dedicated circuit, implementing:
a detection data acquirer that acquires detection data required for trigger condition determinations;
a trigger condition determiner that performs the trigger condition determinations based on the detection data according to the combining way of the trigger conditions;
a collection data generator that generates the collection data based on determination results of the trigger condition determinations; and
a data transmitter that transmits the collection data to the center device.

15. A data processing method executed in a data communication system in which a center device and a vehicular device mounted on a vehicle are capable of data communication with each other,
the data processing method comprising:
by the center device, generating trigger conditions for detecting a given scene of the vehicle;
by the center device, generating a combining way of the trigger conditions;
by the center device, generating a collection data list corresponding to the trigger conditions;
by the center device, delivering the trigger conditions, the combining way, and the collection data list to the vehicular device;
by the center device, acquiring collection data indicated in the collection data list from the vehicular device;
by the vehicular device, acquiring detection data required for trigger condition determinations;
by the vehicular device, performing the trigger condition determinations based on the detection data according to the combining way of the trigger conditions;
by the vehicular device, generating collection data based on determination results of the trigger condition determinations; and
by the vehicular device, transmitting the collection data to the center device.

16. A data processing method executed in a center device capable of data communication with a vehicular device mounted on a vehicle, wherein the vehicular device, based on detection data required for trigger condition determinations, performs the trigger condition determinations according to a combining way of trigger conditions, generates collection data based on determination results of the trigger condition determinations, and transmits the collection data to the center device,
the data processing method comprising:
generating the trigger conditions for detecting a given scene of the vehicle;
generating the combining way of the trigger conditions;
generating a collection data list corresponding to the trigger conditions;
delivering the trigger conditions, the combining way, and the collection data list to the vehicular device; and
acquiring the collection data from the vehicular device.

17. A data processing method executed in a vehicular device mounted on a vehicle and capable of data communication with a center device, wherein the center device generates trigger conditions for detecting a given scene of the vehicle, generates a combining way of the trigger conditions, generates a collection data list corresponding to the trigger conditions, delivers the trigger conditions, the combining way, and the collection data list to the vehicular device, and acquires collection data indicated in the collection data list from the vehicular device,
the data processing method comprising:
acquiring detection data required for trigger condition determinations;
performing the trigger condition determinations based on the detection data according to the combining way of the trigger conditions;
generating collection data based on determination results of the trigger condition determinations; and
transmitting the collection data to the center device.

18. A data processing program stored in a non-transitory storage medium for a center device capable of data communication with a vehicular device mounted on a vehicle, wherein the vehicular device, based on detection data required for trigger condition determinations, performs the trigger condition determinations according to a combining way of trigger conditions, generates collection data based on determination results of the trigger condition determinations, and transmits the collection data to the center device,
the data processing program causing a computer of the center device to execute:
generating the trigger conditions for detecting a given scene of the vehicle;
generating the combining way of the trigger conditions;
generating a collection data list corresponding to the trigger conditions;
delivering the trigger conditions, the combining way, and the collection data list to the vehicular device; and
acquiring the collection data from the vehicular device.

19. A data processing program stored in a non-transitory storage medium for a vehicular device mounted on a vehicle and capable of data communication with a center device, wherein the center device generates trigger conditions for detecting a given scene of the vehicle, generates a combining way of the trigger conditions, generates a collection data list corresponding to the trigger conditions, delivers the trigger conditions, the combining way, and the collection data list to the vehicular device, and acquires collection data indicated in the collection data list from the vehicular device,
the data processing program causing a computer of the vehicular device to execute:
acquiring detection data required for trigger condition determinations;
performing the trigger condition determinations based on the detection data according to the combining way of the trigger conditions;
generating collection data based on determination results of the trigger condition determinations; and
transmitting the collection data to the center device.
